(19) United States
(12) Patent Application Publication
(10) Pub. No.: US 2006/0031093 A1
(43) Pub. Date: Feb. 9, 2006

(54) Computerized method and system for communicating agreements and/or discrepancies in image interpretation

(76) Inventors: Laura Kathleen Serrano, Lenexa, KS (US); John Lee Moore III, Independence, MO (US); Shirley M. Fagereng, Lawrence, KS (US)

Correspondence Address: SHOOK, HARDY & BACON L.L.P.;Intellectual Property Department, 2555 GRAND BOULEVARD, KANSAS CITY, MO, 64108-2613, US

(21) Appl. No.: 10/911,276

(22) Filed: Aug. 4, 2004

(51) Int. Cl. G06Q 50/00

(52) U.S. Cl. 705/2; 382/128

(57) ABSTRACT

A computerized method for communicating agreements and/or discrepancies in image interpretation, e.g., diagnostic image interpretation, is provided. The method includes receiving a first interpretation of a diagnostic image, receiving a second interpretation of the diagnostic image, determining whether there is a discrepancy between the first and second image interpretations, and communicating the agreement or discrepancy. A computerized method and system for capturing and storing one or more data points related to the diagnostic image for use in auditing and/or peer review processes is also provided.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

The present invention relates generally to the field of computer software. More particularly, the present invention relates to a computerized method and system for communicating agreements and/or discrepancies in image interpretation, e.g., medical diagnostic image interpretation. The present invention further relates to a computerized method and system for capturing and storing one or more data points related to the diagnostic image for use in auditing and/or peer review processes.

### BACKGROUND OF THE INVENTION

A common process in image interpretation, e.g., medical diagnostic image interpretation, involves multiple reads or interpretations of a single image. This is particularly true of time-sensitive situations, for instance, when diagnostic images are taken in a hospital emergency department or clinic. In such situations, a so-called “wet read” is often performed at a point in time relatively close to the time when the image is actually taken or otherwise obtained. “Wet read” is a radiology term that originated at a time when diagnostic images, e.g., x-rays, were manually processed, that is, taken and developed on film. In an effort at efficiency, or when time was of the essence, a physician or other qualified individual would often read the image and perform a quick initial interpretation while the film was still wet. Even in today's era where diagnostic images are primarily in a digital format, the term survives and refers to a situation wherein an interpreter, e.g., a physician, performs a quick initial interpretation of a diagnostic image. The initial image interpreter may be a referring physician, a department physician (e.g., an emergency department physician), a radiologist, a clinician, or any other individual qualified and charged with the authority to interpret diagnostic images. For instance, in one scenario, the night shift of a hospital emergency department may not have a radiologist on staff and thus, during the night shift, emergency department physicians may be charged with diagnostic image interpretation. However, as emergency department physicians are not specially trained in image interpretation, the images may later be reviewed by a specialist, i.e., a radiologist, and a report issued.

If, in the above scenario, the radiologist disagrees with the emergency department physician's interpretation of the diagnostic image, notification of the interpretation discrepancy must be made. For instance, contemplate a scenario in which a patient arrives at the emergency department (ED) in the middle of the night complaining of severe pain and swelling in his/her ankle. A diagnostic image (e.g., an x-ray) may be taken and examined by an emergency department physician who may interpret the image as showing no fracture. The emergency department physician may then accordingly provide the patient with the proverbial instruction, “take two aspirin and call me in the morning.” The next morning, a radiologist may review the patient's diagnostic image and determine that the image indicates an ankle fracture. That radiologist needs to know that the emergency department physician interpreted the image as having no fracture and, more importantly, the course of treatment prescribed by the emergency department physician. Additionally, the patient must to be contacted and instructed to promptly return to the emergency department or to contact another physician for casting or the like.

The above-described process is currently a paper process. That is, the diagnostic image is taken (or otherwise obtained) and interpreted by, for example, an emergency department physician. The emergency department physician manually documents his/her diagnostic image interpretation and prescribed course of treatment on a piece of paper. This manual documentation takes place in the patient's paper medical record. The patient may then be treated (for example, instructed to take two aspirin and call in the morning) and released.

At some point later in time, a radiologist may receive the piece of paper on which the emergency department physician's findings and course of treatment are documented along with the diagnostic image. The radiologist may then review the diagnostic image and, if he/she disagrees with the initial interpretation, note the disagreement, potentially on another piece of paper. Subsequently, the diagnostic image itself, the emergency department physician's interpretation, the initial prescribed course of treatment, the radiologist's interpretation, and any recommended modification in the course of treatment must all be compiled, maintained together, and correctly documented in the patient's paper medical record. Additionally, any disagreement or discrepancy between the interpretations of the diagnostic image, as well as any recommended modification in the course of treatment must be communicated to the patient.

Essentially, one or more pieces of paper must stay together and stay with the diagnostic image in order to ensure that the appropriate individuals have access to all the relevant information when required during a number of steps throughout the course of events. This highly inefficient method of interpretation and documentation is prone to human error at several junctures, with the consequences of such errors being potentially life-threatening. Additionally, this method does not facilitate communication of interpretation discrepancies.

In current practice there is also limited statistical analysis, if any, of image interpretation discrepancies. That is, there is no efficient way of learning, for instance, that a particular emergency department physician has incorrectly interpreted ankle x-rays nine out of the last ten times he or she has been asked to examine such x-rays. Accordingly, while patient care in the emergency department may be improved by providing that particular emergency department physician with a supplemental training session directed to ankle x-ray interpretation, there is currently no efficient way of discovering the necessity for training.

In view of the above, the inventors hereof have recognized that a paperless mechanism for communicating agreements and/or discrepancies in diagnostic image interpretation would be desirable. Additionally, a mechanism to aid in prompt notification of an incorrect image interpretation and the concurrent prompt modification of patient care would be advantageous. Still further, a mechanism to capture statistics and image links relating to images having interpretation discrepancies such that such discrepancies may be learned from and minimized in the future would be advantageous.

### SUMMARY OF THE INVENTION

The present invention provides a method in a computing environment for communicating agreements and discrepancies in image interpretation, e.g., medical diagnostic image interpretation. The method may include receiving a first interpretation of at least one diagnostic image, receiving a second interpretation of the diagnostic image and, if there is a discrepancy between the first and second interpretations, communicating the discrepancy. In one embodiment, the first interpretation may be provided, for instance, by an individual who is not a specialist in diagnostic image interpretation, e.g., an emergency department physician, whereas the second interpretation may be provided by an individual who is a diagnostic image interpretation specialist, e.g., a radiologist. Communicating any discrepancy between the first and second diagnostic image interpretations may include communicating the discrepancy via one or more of an email, pager, telephone, and a data-sharing application. The method may further include storing one or more of the diagnostic image, the first interpretation, the second interpretation, and an indication of the discrepancy as a part of an electronic record, e.g., an electronic medical record. Additionally, the method of the present invention may include receiving an indication of a course of action based upon the first image interpretation and storing the course of action within the electronic record. If a modified course of action is indicated based upon the second image interpretation, the method may include receiving the modified course of action and storing the modified course of action within the electronic record.

In one embodiment, the method of the present invention may further include capturing at least one data point related to the diagnostic image and storing the data point in an electronic file, e.g., an electronic teaching file. Capturing the at least one data point may include capturing at least one of the diagnostic image, the first diagnostic image interpretation, the second diagnostic image interpretation, an identification of a first image interpreter (e.g., the emergency department physician), an identification of a second image interpreter (e.g., the radiologist), a time of the first diagnostic image interpretation, a time of the second diagnostic image interpretation, the discrepancy indication and a severity classification for the discrepancy.

The present invention further provides a method in a computing environment for communicating discrepancies in diagnostic image interpretation which includes receiving a first interpretation of at least one diagnostic image, receiving an indication of a discrepancy between the first and second image interpretations, and reporting the discrepancy indication. The discrepancy indication may be communicated via one or more of an email, pager, telephone, and a data-sharing application. The method may further include storing one or more of the diagnostic image, the first interpretation, the second interpretation and the discrepancy indication within an electronic record, for instance, an electronic medical record.

Still further, the present invention provides a method in a computing environment for communicating agreements in diagnostic image interpretation. The method comprises receiving a first interpretation of at least one diagnostic image, receiving an indication of an agreement between the first interpretation of the diagnostic image and a second interpretation of the diagnostic image and reporting the agreement indication. In one embodiment, the method may comprise reporting the agreement indication via one or more of an email, pager, telephone, and a data-sharing application.

Computer-readable media having computer-executable instructions for performing the methods disclosed herein are also provided.

Additionally, the present invention provides a computer system for communicating agreements and discrepancies in image interpretation. The computer system may include a first receiving module for receiving a first interpretation of at least one diagnostic image and a second interpretation of the at least one diagnostic image and a communicating module for communicating at least one of an agreement between the first and second diagnostic image interpretations and a discrepancy between the first and second diagnostic image interpretations. The computer system may further include a storage module for storing at least one of the first interpretation, the second interpretation, the agreement and the discrepancy. Additionally, the computer system may include a capturing module for capturing at least one data point related to the diagnostic image and a reporting module for reporting the at least one data point.

Still further, the present invention provides a computer system for communicating discrepancies in diagnostic image interpretation including means for receiving a first interpretation of at least one diagnostic image and a second interpretation of the at least one diagnostic image. The computer system may further include means for communicating at least one of an agreement between the first and second diagnostic image interpretations and a discrepancy between the first and second diagnostic image interpretations. Additionally, the computer system may further include means for storing at least one of the first interpretation, the second interpretation, the agreement and the discrepancy. Still further, the computer system may include means for capturing at least one data point related to the diagnostic image and means for reporting the at least one data point.

### BRIEF DESCRIPTION OF THE SEVERAL VIEWS OF THE DRAWINGS

The present invention is described in detail below with reference to the attached drawing figures, wherein:

FIG. 1 is a block diagram of a computing system environment suitable for use in implementing the present invention;

FIGS. 2A-2C are a flow chart representative of a computer program for reporting agreements and/or discrepancies in diagnostic image interpretation in accordance with an embodiment of the present invention;

FIG. 3 is a schematic of an illustrative screen display showing documentation of an initial diagnostic image interpretation in accordance with an embodiment of the present invention;

FIG. 4 is a schematic of an illustrative screen display showing more in-depth documentation of an initial diagnostic image interpretation than that shown in FIG. 3; and

FIG. 5 is a schematic of an illustrative screen display showing review of the initial diagnostic image interpretation of FIG. 3, as well as documentation of a second interpretation of the same diagnostic image, wherein disagreement (discrepancy) with the initial image interpretation is indicated.

### DETAILED DESCRIPTION OF THE INVENTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and or “block” may be used herein to connote different elements of methods employed, the terms should not be interpreted as implying any particular order among or between various steps herein disclosed unless and except when the order of individual steps is explicitly described.

The present invention provides a computerized method and system for communicating agreements and/or discrepancies in image interpretation, e.g., medical diagnostic image interpretation. Additionally, the present invention provides a method and system for capturing and storing one or more data points related to the diagnostic image for use in auditing and/or peer review processes. An exemplary operating environment for the present invention is described below.

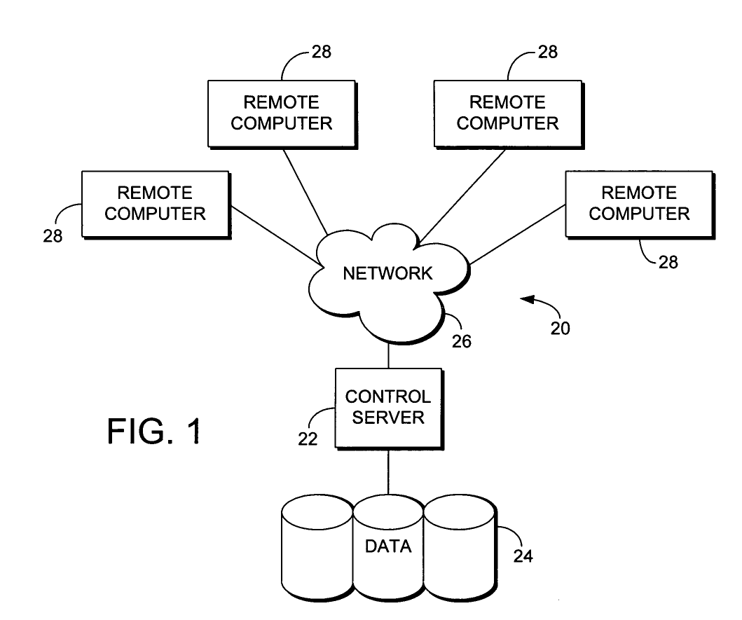

Referring to the drawings in general, and initially to FIG. 1 in particular, wherein like reference numerals identify like components in the various figures, an exemplary computing system environment, for instance, a medical information computing system environment, on which the present invention may be implemented is illustrated and designated generally as reference numeral 20. It will be understood and appreciated by those of ordinary skill in the art that the illustrated medical information computing system environment 20 is merely an example of one suitable computing environment and is not intended to suggest any limitation as to the scope of use or functionality of the invention. Neither should the medical information computing system environment 20 be interpreted as having any dependency or requirement relating to any single component or combination of components illustrated therein.

The present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in local and/or remote computer storage media including, by way of example only, memory storage devices.

With continued reference to FIG. 1, the exemplary medical information computing system environment 20 includes a general purpose computing device in the form of a control server 22. Components of the control server 22 may include, without limitation, a processing unit, internal system memory, and a suitable system bus for coupling various system components, including database cluster 24, with the control server 22. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 22 typically includes therein, or has access to, a variety of computer readable media, for instance, database cluster 24. Computer readable media can be any available media that may be accessed by control server 22, and includes volatile and nonvolatile media, as well as removable and nonremovable media. By way of example, and not limitation, computer readable media may include computer storage media and communication media. Computer storage media may include, without limitation, volatile and nonvolatile media, as well as removable and nonremovable media implemented in any method or technology for storage of information, such as computer readable instructions, data structures, program modules, or other data. In this regard, computer storage media may include, but is not limited to, RAM, ROM, EEPROM, flash memory or other memory technology, CD-ROM, digital versatile disks (DVDs), or other optical disk storage, magnetic cassettes, magnetic tape, magnetic disk storage, or other magnetic storage device, or any other medium which can be used to store the desired information and which may be accessed by control server 22. Communication media typically embodies computer readable instructions, data structures, program modules, or other data in a modulated data signal, such as a carrier wave or other transport mechanism, and may include any information delivery media. As used herein, the term “modulated data signals” refers to a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer readable media.

The computer storage media discussed above and illustrated in FIG. 1, including database cluster 24, provide storage of computer readable instructions, data structures, program modules, and other data for control server 22.

The control server 22 may operate in a computer network 26 using logical connections to one or more remote computers 28. Remote computers 28 may be located at a variety of locations in a medical environment, for example, but not limited to, clinical laboratories, hospitals and other inpatient settings, ambulatory settings, medical billing and financial offices, hospital administration settings, home health care environments, and clinicians' offices. Clinicians may include, but are not limited to, a treating physician or physicians, specialists such as surgeons, radiologists and cardiologists, emergency medical technicians, physicians' assistants, nurse practitioners, nurses, nurses' aides, pharmacists, dieticians, microbiologists, and the like. Remote computers 28 may also be physically located in non-traditional medical care environments so that the entire health care community may be capable of integration on the network. Remote computers 28 may be personal computers, servers, routers, network PCs, peer devices, other common network nodes, or the like, and may include some or all of the elements described above in relation to the control server 22.

Exemplary computer networks 26 may include, without limitation, local area networks (LANs) and/or wide area networks (WANs). Such networking environments are commonplace in offices, enterprise-wide computer networks, intranets, and the Internet. When utilized in a WAN networking environment, the control server 22 may include a modem or other means for establishing communications over the WAN, such as the Internet. In a networked environment, program modules or portions thereof may be stored in the control server 22, in the database cluster 24, or on any of the remote computers 28. For example, and not by way of limitation, various application programs may reside on the memory associated with any one or all of the remote computers 28. It will be appreciated by those of ordinary skill in the art that the network connections shown are exemplary and other means of establishing a communications link between the computers (e.g., control server 22 and remote computers 28) may be utilized.

In operation, a user may enter commands and information into the control server 22 or convey the commands and information to the control server 22 via one or more of the remote computers 28 through input devices, such as a keyboard, a pointing device (commonly referred to as a mouse), a trackball, or a touch pad. Other input devices may include, without limitation, microphones, satellite dishes, scanners, or the like. The control server 22 and/or remote computers 28 may include other peripheral output devices, such as speakers and a printer.

Although many other internal components of the control server 22 and the remote computers 28 are not shown, those of ordinary skill in the art will appreciate that such components and their interconnection are well known. Accordingly, additional details concerning the internal construction of the control server 22 and the remote computers 28 are not further disclosed herein.

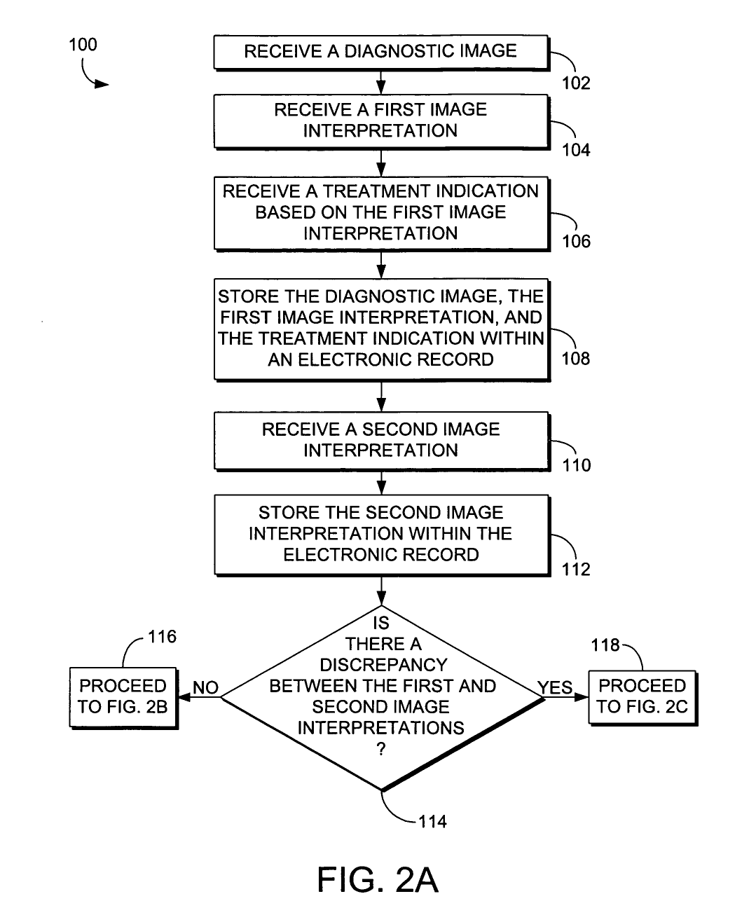

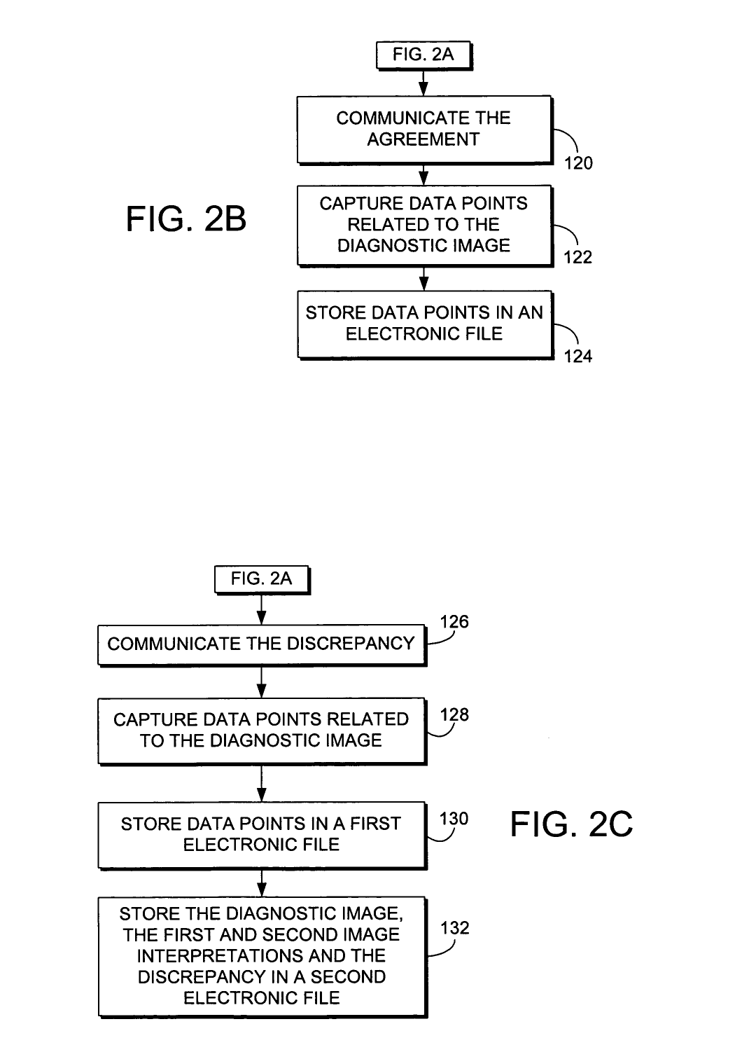

Turning now to FIGS. 2A-2C, a method 100, which may be implemented on the above-described exemplary computing system environment 20 (FIG. 1) for reporting agreements and/or discrepancies in image interpretation is provided. By way of example only, the method 100 of FIGS. 2A-2C may be utilized to capture and store medical diagnostic images, and one or more interpretations thereof, such that interpretation discrepancies and the necessity for course of treatment modifications may be recognized and communicated more efficiently than prior paper methods. Additionally, the method 100 may be utilized to facilitate capture of statistical data for use in auditing and peer review processes.

Initially, at block 102, the system receives a diagnostic image, e.g., a diagnostic x-ray or the like, having data shown thereon particular to an individual, for instance, an individual presenting in a hospital emergency department complaining of severe ankle pain and/or swelling. It should be noted that the terms “individual”, “person”, and “patient” are used interchangeably herein and are not meant to limit the nature of the referenced individual in any way. Rather, the methods and systems described herein are equally applicable in, for instance, a veterinary setting. Further, use herein of the term “patient” is not meant to imply any particular relationship between the individual in question and those interpreting that individual's diagnostic images. Nor is the use of terms such as “physician” and/or “clinician” meant to imply any particular relationship between the referenced individual and those whose diagnostic images are being interpreted.

Subsequently, as shown at block 104, the system receives a first interpretation of the received diagnostic image, the first interpretation being performed by a first interpreter. It will be understood and appreciated by those of ordinary skill in the art that the first interpreter may be, without limitation, any qualified physician, clinician, or other individual charged with the authority to interpret diagnostic images. For instance, the first interpreter may be an emergency department physician or a referring physician.

Next, as shown at block 106, the system receives a prescribed course of treatment (“treatment indication”) based upon the first image interpretation. The system then stores at least one of the diagnostic image, the first image interpretation, and the treatment indication within an electronic record, e.g., the patient's electronic medical record (EMR). This is shown at block 108.

Subsequently, and typically at an instance separated in time from the first interpretation, the system receives a second interpretation of the received diagnostic image. This is shown at block 110. The second image interpretation may be performed by the same interpreter as the first image interpretation or, more typically, may be performed by a second interpreter, for instance, a radiologist. If desired, the system may then store the second image interpretation within the electronic record, as shown at block 112.

It is next determined whether there is a discrepancy between the first and second image interpretations. This determination, which may be performed manually by a user or automatically by the system, is indicated at block 114 of FIG. 2A. If there is a discrepancy between the first and second image interpretations, the method may proceed to the steps shown in FIG. 2B, as indicated at block 116. If, however, there is not a discrepancy between the first and second image interpretations, the method may proceed to the steps shown in FIG. 2C, as indicated at block 118.

In operation, by way of example only, suppose an individual by the name of Lisa Kramer presents to a hospital emergency department after standard office hours complaining of severe ankle pain and swelling. An emergency department physician, Dr. John Doe, examines Miss Kramer's ankle and orders an x-ray. Shortly after the x-ray has been obtained, Dr. Doe examines the x-ray and determines that no fracture is shown. Dr. Doe subsequently informs Miss Kramer that the ankle is not fractured and sends her home with instructions to take an over-the-counter pain reliever and follow-up with her primary care physician in the morning if the pain and/or swelling has not subsided. Dr. Doe inputs his diagnostic image interpretation and prescribed course of treatment into a computer, e.g., one of the remote computers 28 of the computing system environment 20 (FIG. 1), using one or more input devices. The system subsequently stores at least one of the diagnostic image, Dr. Doe's interpretation of the diagnostic image, and the prescribed course of treatment within an electronic record, e.g., Miss Kramer's electronic medical record (EMR). In a currently preferred embodiment, each of the diagnostic image, Dr. Doe's interpretation of the diagnostic image, and the prescribed course of treatment are stored within Miss Kramer's EMR.

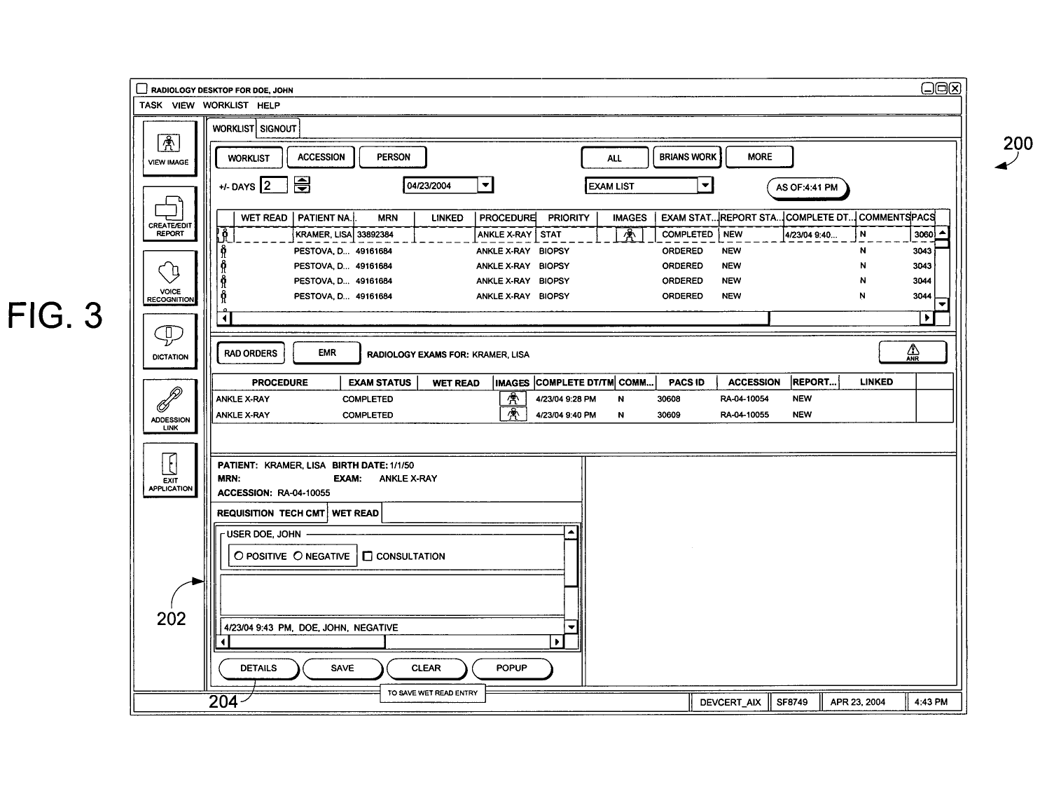

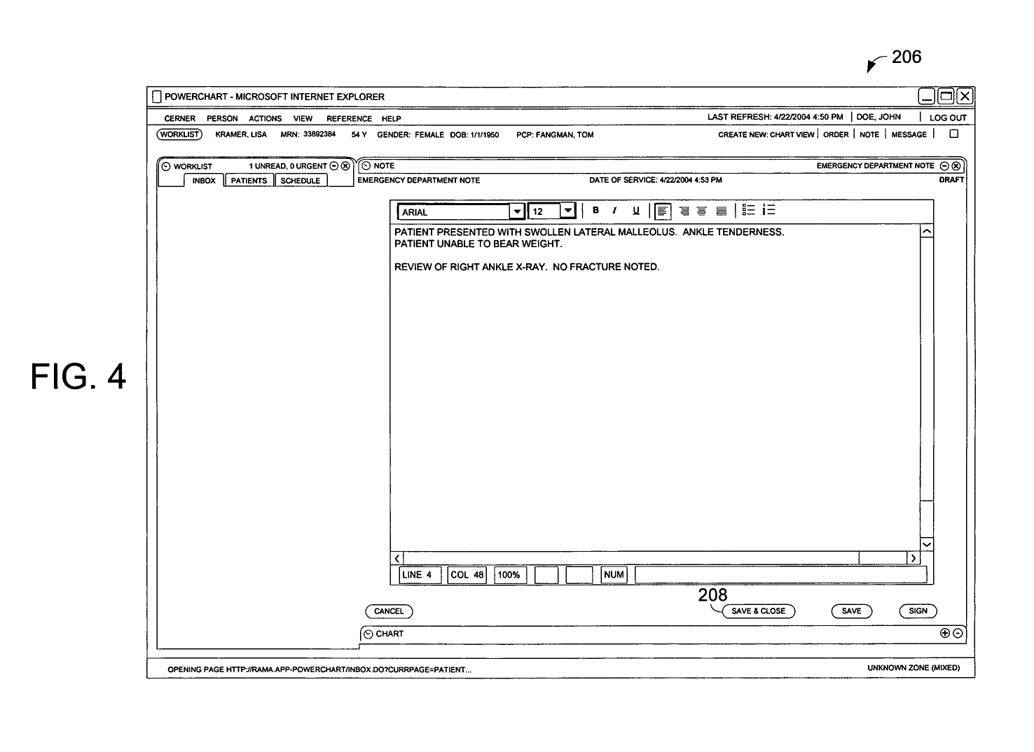

FIG. 3 is a schematic of an illustrative screen display 200 showing Dr. Doe's documentation of his initial diagnostic image interpretation in accordance with an embodiment of the present invention. The screen display 200, which includes information that is a part of Lisa Kramer's EMR, indicates that an ankle x-ray had been ordered and completed. In an interpretation region 202 illustrated at the bottom left of the screen display 200, it is indicated that Dr. Doe interpreted the ankle x-ray as showing no fracture. By hovering over and selecting a Details button 204 beneath the initial interpretation, the illustrative screen display 206 of FIG. 4 may be accessible wherein Dr. Doe may document more details of his visit with Miss Kramer and his interpretation of the ankle x-ray. Though not shown in FIG. 4, in one embodiment, Dr. Doe may also input the prescribed course of treatment so that it may be accessible by a subsequent user of the data-sharing application. Once his documentation is completed, Dr. Doe may select the Save & Close button 208 and return to the illustrative screen display 200 of FIG. 3, the note entered in the documentation shown in FIG. 4 being stored within Miss Kramer's EMR.

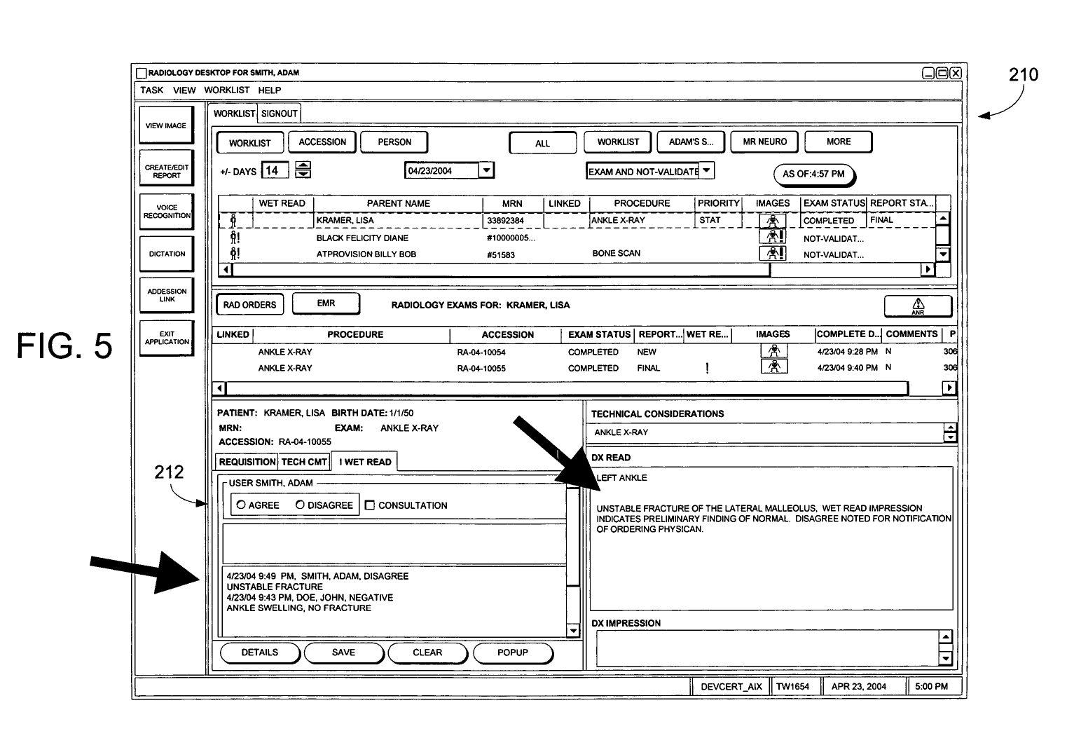

Now suppose that the next morning, a radiologist by the name of Dr. Adam Smith accesses Miss Kramer's electronic medical record (EMR) (wherein the diagnostic image is stored), independently examines the diagnostic image, and inputs his interpretation into Miss Kramer's EMR. Dr. Smith's interpretation of the diagnostic image is subsequently stored within Miss Kramer's EMR. FIG. 5 is an illustrative screen display 210 showing Dr. Smith's documentation of his diagnostic image interpretation in accordance with an embodiment of the present invention. By accessing Miss Kramer's EMR, Dr. Smith is able to view both the ankle x-ray and Dr. Doe's interpretation as well as input his interpretation of the ankle x-ray.

Next, it is determined, either automatically by the system or manually by Dr. Smith, whether there is a discrepancy between the first interpretation of the diagnostic image and the second interpretation of the diagnostic image. In the embodiment illustrated in FIG. 5, Dr. Smith is provided with the option at block 212 to indicate agreement, disagreement, or whether a consultation may be necessary.

With reference to FIG. 2B, if it is determined that there is no discrepancy between the first and second image interpretations, the system may communicate this agreement, as indicated at block 120. In one embodiment, the agreement may be communicated by simply setting forth the two interpretations in a logical orientation such that the agreement between them may be readily apparent to the communication recipient. For instance, if a written communication is provided, the two image interpretations may appear in side-by-side orientation. However, if an audio communication is provided, the first interpretation may be audibly presented followed by the second interpretation. In another embodiment, an agreement indicator such as the phrase “DIAGNOSTIC INTERPRETATIONS AGREE” may be communicated. In yet another embodiment, both an agreement indicator and the interpretations may be communicated. All such variations are contemplated to be within the scope of the present invention.

Communication of the agreement (and/or an indication thereof) may take place by a variety of communication mechanisms including, but not limited to, an email, pager, telephone, a data-sharing application, and any combination thereof. Additionally, the agreement (and/or an indication thereof) may be communicated to a variety of individuals including, but not limited to, the first interpreter, the second interpreter (if necessary), a referring clinician (if any), the patient's primary care physician, the patient, and any combination thereof. It will be understood and appreciated by those of ordinary skill in the art that if the agreement had been manually determined by a user at block 114 of FIG. 2A, and if that user was the second interpreter, communication to this individual would be unnecessary. If, however, the agreement had been automatically determined by the system at block 114 of FIG. 2A, communication to the second interpreter likely would be desirable.

Subsequently, as indicated at block 122 of FIG. 2B, one or more data points related to the diagnostic image and its interpretations may be captured. Data points include, without limitation, the diagnostic image, the first diagnostic image interpretation, the second diagnostic image interpretation, an identification of a first image interpreter (e.g., the emergency department physician), an identification of a second image interpreter (e.g., the radiologist), a time of the first diagnostic image interpretation, a time of the second diagnostic image interpretation, the agreement indication, and an indication of to whom the agreement between interpretations has been communicated. As indicated at block 124, the captured data points may subsequently be stored in an electronic file, such as a teaching file, for use in, for instance, auditing and/or peer review processes.

In operation, by way of example only, suppose the radiologist in the above-described scenario, Dr. Smith, interpreted the patient's (Miss Kramer's) ankle x-ray as showing no fracture, in agreement with the emergency department physician's (Dr. Doe's) interpretation. This agreement, or an indication thereof, may be communicated to, for instance, one or more of Dr. Doe, Dr. Smith (if necessary), Miss Kramer's primary care physician, a referring physician (if any), Miss Kramer, and any combination thereof. As the first and second diagnostic image interpretations are in agreement, it is not necessary that such communications take place in a particularly time-sensitive manner. Accordingly, such communications may most likely take place via an email or the like.

The system may subsequently capture one or more data points including, but not limited to, the ankle x-ray, the identity of the emergency department physician (Dr. Doe), Dr. Doe's interpretation of the x-ray, the identity of the radiologist (Dr. Smith), Dr. Smith's interpretation of the x-ray, and an indication of the agreement between the two diagnostic image interpretations. The data points may then be saved to an electronic file, e.g., a teaching file, for use in subsequent auditing and/or peer review processes.

With reference to FIG. 2C, if it is alternatively determined that there is a discrepancy between the first and second diagnostic image interpretations, the system may communicate this discrepancy, as indicated at block 126. In one embodiment, the discrepancy may be communicated by setting forth the two interpretations in logical orientation with respect to one another such that the discrepancy is readily apparent to the communication recipient. In another embodiment, a discrepancy indicator such as the phrase “DIAGNOSTIC INTERPRETATION DISCREPANCY” may be communicated. In yet another embodiment, both a discrepancy indicator and the interpretations may be communicated.

As with the scenario wherein the diagnostic interpretations were in agreement, any discrepancy between interpretations (and/or an indication thereof) may be communicated by a variety of mechanisms including, without limitation, an email, pager, telephone, a data-sharing application, and any combination thereof. If the discrepancy is of a severe enough nature that a modification in the prescribed course of treatment may be warranted, it is currently preferred that at least one relatively immediate form of communication, e.g., a pager and/or telephone, be utilized. Additionally, the discrepancy (and/or an indication thereof) may be communicated to a variety of individuals including, without limitation, the first interpreter, the second interpreter (if necessary), a referring clinician (if any), the patient's primary care physician, the patient, and any combination thereof. If the discrepancy is of a severe enough nature that a modification in the prescribed course of treatment may be warranted, it is currently preferred that at least the first interpreter and the second interpreter (if necessary) are notified in a timely fashion.

Subsequently, as indicated at block 128, one or more data points related to the diagnostic image and its interpretations may be captured. Data points may include, by way of example only, the diagnostic image, the first diagnostic image interpretation, the second diagnostic image interpretation, an identification of a first image interpreter (e.g., the emergency department physician), an identification of a second image interpreter (e.g., the radiologist), a time of the first diagnostic image interpretation, a time of the second diagnostic image interpretation, the discrepancy indication, a severity classification for the discrepancy, and an indication of the parties to which the discrepancy between interpretations has been communicated. As indicted at block 130, the captured data points may subsequently be stored in an electronic file, such as a teaching file, for use in, for instance, auditing and/or peer review processes.

As an additional peer review tool, the diagnostic image itself, along with the first and second interpretations thereof, may be stored in a second electronic file, as indicated at block 132. In one embodiment, this diagnostic image and interpretations thereof may be free of any identifying data (e.g., free of the identity of the first and second interpreters) such that the second electronic file may be used, e.g., as an learning tool in one or more continuing education sessions.

In operation, by way of example only, suppose the radiologist in the above-described scenario (Dr. Smith) interpreted the patient's (Miss Kramer's) ankle x-ray as showing a fracture, contrary to the emergency department physician's (Dr. Doe's) interpretation. This discrepancy, or an indication thereof, may be communicated to, for instance, one or more of the Dr. Doe, Dr. Smith (if necessary), Miss Kramer's primary care physician, a referring physician (if any), Miss Kramer, and any combination thereof. As there is a discrepancy between the first and second diagnostic image interpretations in this scenario, it is currently preferred that communications of such discrepancy take place in at least one time-sensitive manner. Accordingly, such communications may most likely take place via pager or telephone. At the very least, it is currently preferred that the discrepancy be communicated to Dr. Doe in a time-sensitive manner so that he may promptly examine the prescribed course of treatment in view of Dr. Smith's interpretation, determine whether or not a modified course of treatment is warranted and, if a new course of treatment is warranted, promptly inform Miss Kramer. In the present scenario, as Miss Kramer's ankle is fractured, Dr. Doe (or other individual whom he instructs) should promptly contact Miss Kramer and instruct her to return to the emergency department or visit another physician for casting of the ankle, or the like.

The system may subsequently capture one or more data points including, but not limited to, the ankle x-ray, the identity of the emergency department physician (Dr. Doe), Dr. Doe's interpretation of the x-ray, the identity of the radiologist (Dr. Smith), Dr. Smith's interpretation of the x-ray, and an indication of the discrepancy between the two diagnostic image interpretations. The data points may then be saved to a first electronic file, e.g., a teaching file, for use in subsequent auditing and/or peer review processes. Additionally, the diagnostic image itself, along with the first and second interpretations thereof, may be stored in a second electronic file for use as a learning tool in, for instance, one or more continuing education sessions.

In summary, the present invention provides computerized methods and systems for communicating agreements and/or discrepancies in image interpretation, for instance, medical diagnostic image interpretation. Additionally, the present invention provides computerized methods and systems for capturing and storing one or more data points related to a diagnostic image for use in auditing and/or peer review processes. Although the invention has been described with reference to the preferred embodiments illustrated in the attached drawing figures, it is noted that substitutions may be made and equivalents employed herein without departing from the scope of the invention recited in the claims. For instance, additional steps may be added and steps may be omitted without departing from the scope of the invention.

The invention claimed is:

1. A method in a computing environment for communicating discrepancies in diagnostic image interpretation, the method comprising:
receiving a first interpretation of at least one diagnostic image;
receiving a second interpretation of the diagnostic image; and
if there is a discrepancy between the first and second interpretations, communicating the discrepancy.

2. The method of claim 1, wherein communicating the discrepancy between the first and second diagnostic image interpretations comprises communicating the discrepancy via one or more of an email, pager, telephone, and a data-sharing application.

3. The method of claim 1, wherein communicating the discrepancy between the first and second diagnostic image interpretations comprises:
receiving an indication of the discrepancy between the first interpretation and the second interpretation; and
communicating the discrepancy indication.

4. The method of claim 3, further comprising storing one or more of the first interpretation of the diagnostic image, the second interpretation, and the discrepancy indication as a part of an electronic record.

5. The method of claim 4, further comprising:
receiving the diagnostic image; and
storing the diagnostic image as a part of the electronic record.

6. The method of claim 4, further comprising:
receiving an indication of a course of action based upon the first image interpretation; and
storing the course of action indication as a part of the electronic record.

7. The method of claim 6, further comprising:
receiving an indication of a modified course of action based upon the second image interpretation; and
storing the modified course of action as a part of the electronic record.

8. The method of claim 3, further comprising:
capturing at least one data point related to the diagnostic image; and
storing the data point in an electronic file.

9. The method of claim 8, wherein capturing at least one data point related to the diagnostic image comprises capturing at least one of the diagnostic image, the first diagnostic image interpretation, the second diagnostic image interpretation, an identification of a first image interpreter, an identification of a second image interpreter, a time of the first diagnostic image interpretation, a time of the second diagnostic image interpretation, the discrepancy indication, and a severity classification for the discrepancy.

10. The method of claim 8, further comprising using the at least one data point in at least one of an auditing process and a peer review process.

11. The method of claim 1, wherein if there is agreement between the first and second diagnostic image interpretations, communicating the agreement.

12. The method of claim 11, wherein communicating the agreement between the first and second diagnostic image interpretations comprises communicating the agreement via one or more of an email, pager, telephone, and a data-sharing application.

13. The method of claim 11, wherein communicating the agreement comprises:
receiving an indication of the agreement between the first interpretation and the second interpretation; and
communicating the agreement indication.

14. The method of claim 13, further comprising:
capturing at least one data point related to the diagnostic image; and
storing the data point in an electronic file.

15. The method of claim 14, wherein capturing one or more data points related to the diagnostic image comprises capturing one or more of the diagnostic image, the first diagnostic image interpretation, the second diagnostic image interpretation, an identification of a first image interpreter, an identification of a second image interpreter, a time of the first diagnostic image interpretation, a time of the second diagnostic image interpretation, and the agreement indication.

16. The method of claim 14, further comprising using the at least one data point in at least one of an auditing process and a peer review process.

17. A method in a computing environment for communicating discrepancies in diagnostic image interpretation, the method comprising:
receiving a first interpretation of at least one diagnostic image;
receiving an indication of a discrepancy between the first interpretation of the diagnostic image and a second interpretation of the diagnostic image; and
communicating the discrepancy indication.

18. The method of claim 17, wherein communicating the discrepancy indication comprises communicating the discrepancy indication via one or more of an email, pager, telephone, and a data-sharing application.

19. The method of claim 17, further comprising receiving the second interpretation of the diagnostic image.

20. The method of claim 17, further comprising storing one or more of the first interpretation, the second interpretation, and the discrepancy indication as a part of an electronic record.

21. The method of claim 20, further comprising:
receiving the diagnostic image; and
storing the diagnostic image as a part of the electronic record.

22. The method of claim 20, further comprising:
receiving an indication of a course of action based upon the first image interpretation; and
storing the course of action indication as a part of the electronic record.

23. The method of claim 22, further comprising:
receiving an indication of a modified course of action based upon the second image interpretation; and
storing the modified course of action indication as a part of the electronic record.

24. The method of claim 17, further comprising:
capturing at least one data point related to the diagnostic image; and
storing the data point in an electronic file.

25. The method of claim 24, wherein capturing one or more data points related to the diagnostic image comprises capturing one or more of the diagnostic image, the first diagnostic image interpretation, the second diagnostic image interpretation, an identification of a first image interpreter, an identification of a second image interpreter, a time of the first diagnostic image interpretation, a time of the second diagnostic image interpretation, the discrepancy indication, and a severity classification for the discrepancy.

26. The method of claim 24, further comprising using the at least one data point in at least one of an auditing process and a peer review process.

27. A method in a computing environment for communicating agreements in diagnostic image interpretation, the method comprising:
receiving a first interpretation of at least one diagnostic image;
receiving an indication of an agreement between the first interpretation of the diagnostic image and a second interpretation of the diagnostic image; and
communicating the agreement indication.

28. The method of claim 27, wherein communicating the agreement indication comprises communicating the agreement indication via one or more of an email, pager, telephone, and a data-sharing application.

29. The method of claim 27, further comprising:
capturing at least one data point related to the diagnostic image; and
storing the data point in an electronic file.

30. The method of claim 29, wherein capturing one or more data points related to the diagnostic image comprises capturing one or more of the diagnostic image, the first diagnostic image interpretation, the second diagnostic image interpretation, an identification of a first image interpreter, an identification of a second image interpreter, a time of the first diagnostic image interpretation, a time of the second diagnostic image interpretation, and the agreement indication.

31. The method of claim 29, further comprising using the at least one data point in at least one of an auditing process and a peer review process.

32. A computer system for communicating discrepancies in diagnostic image interpretation, the computer system comprising:
a first receiving module for receiving a first interpretation of at least one diagnostic image and a second interpretation of the at least one diagnostic image; and
a communicating module for communicating at least one of an agreement between the first and second diagnostic image interpretations and a discrepancy between the first and second diagnostic image interpretations.

33. The computer system of claim 32, further comprising a storage module for storing at least one of the first interpretation, the second interpretation, the agreement and the discrepancy.

34. The computer system of claim 32, further comprising a capturing module for capturing at least one data point related to the diagnostic image.

35. The computer system of claim 34, further comprising a reporting module for reporting the at least one data point.

36. A computer-readable medium having computer-executable instructions for performing a method, the method comprising:
receiving a first interpretation of at least one diagnostic image;
receiving a second interpretation of the at diagnostic image; and
if there is a discrepancy between the first and second diagnostic image interpretations, communicating the discrepancy.

37. The computer-readable medium of claim 36, wherein if there is an agreement between the first and second diagnostic image interpretations, the method further comprises communicating the agreement.

38. A computer-readable medium having computer-executable instructions for performing a method, the method comprising:
receiving a first interpretation of at least one diagnostic image;
receiving an indication of a discrepancy between the first interpretation of the diagnostic image and a second interpretation of the diagnostic image; and
communicating the discrepancy indication.

39. A computer-readable medium having computer-executable instructions for performing a method, the method comprising:
receiving a first interpretation of at least one diagnostic image;
receiving an indication of an agreement between the first interpretation of the diagnostic image and a second interpretation of the diagnostic image; and
communicating the agreement indication.

40. A computer system for communicating discrepancies in diagnostic image interpretation, the computer system comprising:
means for receiving a first interpretation of at least one diagnostic image and a second interpretation of the at least one diagnostic image; and
means for communicating at least one of an agreement between the first and second diagnostic image interpretations and a discrepancy between the first and second diagnostic image interpretations.

41. The computer system of claim 40, further comprising means for storing at least one of the first interpretation, the second interpretation, the agreement and the discrepancy.

42. The computer system of claim 40, further comprising means for capturing at least one data point related to the diagnostic image.

43. The computer system of claim 42, further comprising means for reporting the at least one data point.
